(19) United States
(12) Patent Application Publication
(10) Pub. No.: US 2009/0319945 A1
(43) Pub. Date: Dec. 24, 2009

(54) INTERFACE FOR USING DESIRED STATE COMMANDS ON A COPY SERVICES MANGEMENT SYSTEM

(75) Inventors: David R. Blea, Tucson, AZ (US); Benjamin J. Randall, Tucson, AZ (US); Todd B. Schlomer, Westminster, CO (US); Wayne Sun, Tucson, AZ (US); John J. Wolfgang, Midlothian, VA (US)

Correspondence Address: CANTOR COLBURN LLP - IBM TUSCON DIVISION, 20 Church Street, 22nd Floor, Hartford, CT, 06103, US

(73) Assignee: International Business Machines Corporation, Armonk, NY (US)

(21) Appl. No.: 12/142,356

(22) Filed: Jun. 19, 2008

(51) Int. Cl. G06F 3/048

(52) U.S. Cl. 715/810

(57) ABSTRACT

A data replication management interface is provided for selecting a state for replicating data from one site to another site. A pictorial representation of and/or a command line for multiple states is displayed. A pictorial representation of a current state is displayed. Each one of the multiple states respectively corresponds to multiple steps to accomplish each one of the multiple states. The multiple states are configured to be individually selected. An individual selection of one of the multiple states causes the multiple steps for the individual selection to be accomplished. The individual selection of one of the multiple states is selected by a user without requiring the user to choose any of the multiple steps to accomplish the individual selection.

### TRADEMARKS

IBM ® is a registered trademark of International Business Machines Corporation, Armonk, N.Y., U.S.A. Other names used herein may be registered trademarks, trademarks or product names of International Business Machines Corporation or other companies.

### BACKGROUND

1. Field of the Invention

Exemplary embodiments relate to data replication management systems, and particularly to an interface for data replication management systems.

2. Description of Background

In today's computer driven environment, storage of data is an important aspect to consider. Currently, most data replication systems operate on a command basis where a user specifies a certain command and the system carries out the command. In response to an increase in the complexity of such systems, numerous replication management software systems have been created to simplify the overall replication process and thereby reduce the in depth knowledge needed by a user to monitor and maintain his/her replication. To deal with this complexity, such software attempts to reduce the number of available commands and combine more and more individual actions with a single command. Still, most of these software systems work in the same manner on a command by command basis, requiring a user to be knowledgeable about which commands to execute at which points in time to achieve the desired outcome.

A need exists for an interface that offers simplicity without the need to have knowledge of commands to execute data replication.

### SUMMARY OF EXEMPLARY EMBODIMENTS

In accordance with exemplary embodiments, a data replication management interface is provided for selecting a state for replicating data from one site to another site. A pictorial representation of a plurality of states is displayed and/or a command line interface is displayed for the plurality of states. A pictorial representation of a current state is displayed. Each one of the plurality of states respectively corresponds to a plurality of steps to accomplish each one of the plurality of states. The plurality of states is configured to be individually selected. An individual selection of one of the plurality of states causes the plurality of steps for the individual selection to be accomplished. The individual selection of one of the plurality of states is selected by a user without requiring the user to choose any of the plurality of steps to accomplish the individual selection.

System and computer program products corresponding to the above-summarized methods are also described herein.

Additional features and advantages are realized through the techniques of the present invention. Exemplary embodiments of the invention are described in detail herein and are considered a part of the claimed invention. For a better understanding of features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other features and advantages are apparent from the following detailed description taken in conjunction with the accompanying drawings in which:

FIG. 1 illustrates a block diagram of an example configuration that may be used to implement features of exemplary embodiments;

FIG. 2 illustrates a graphical example of how a user interface may be displayed in accordance with exemplary embodiments;

FIG. 3 illustrates a method for providing a data replication management interface for selecting a state to replicate data from one site to another site in accordance with exemplary embodiments; and

FIG. 4 illustrates an example of a computer having capabilities, which may be included in exemplary embodiments.

The detailed description explains exemplary embodiments, together with advantages and features, by way of example with reference to the drawings.

### DETAILED DESCRIPTION OF EXEMPLARY EMBODIMENTS

An example of a data replication management application is the IBM TotalStorage® Productivity Center for Replication v3.4.

IBM TotalStorage® Productivity Center for Replication is designed to provide for the management of IBM FlashCopy®, Metro Mirror, Global Mirror, and Metro/Global Mirror (MGM) capabilities for the IBM Enterprise Storage Server® (ESS) Model 800, DS6000® and DS8000®, while also architected to manage FlashCopy, Metro Mirror, and Global Mirror for the IBM SAN Volume Controller (SVC). Further details regarding IBM TotalStorage® Productivity Center for Replication can be found on the web. Indeed, one skilled in the art understands data replication management systems.

Exemplary embodiments extend the facilitation of data replication management systems, such as the IBM TotalStorage® Productivity Center for Replication and others.

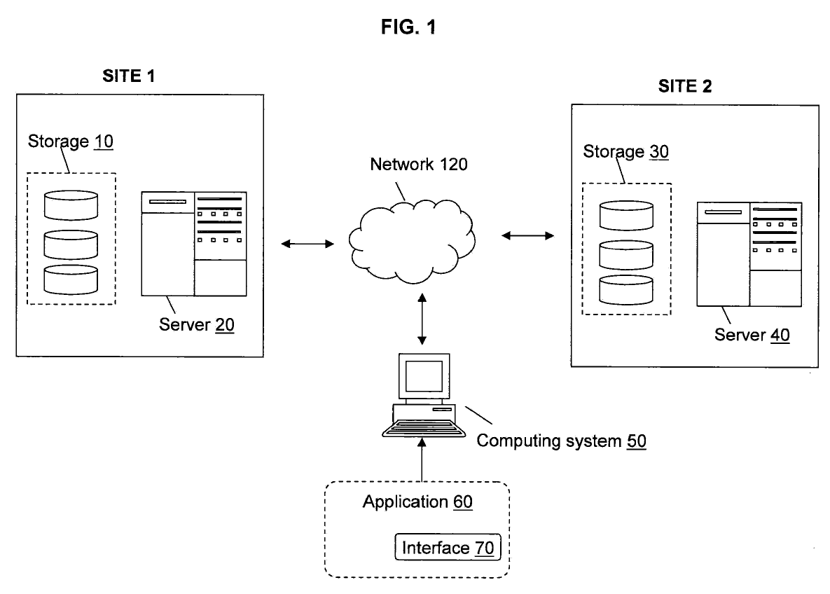

FIG. 1 illustrates a block diagram of an example configuration 100 that may be used to implement features of exemplary embodiments. The described configuration 100 is only one example of such a suitable configuration and is not intended to suggest any limitation as to the scope of use or functionality of exemplary embodiments. Neither should exemplary embodiments be interpreted as having any dependency or requirement relating to any one or combination of components illustrated in FIG. 1.

The configuration 100 may include a plurality of storage sites, such as Site 1 and Site 2. Site 1 may include a plurality of storages 10 and a plurality of servers 20. Site 2 may include a plurality of storages 30 and a plurality of servers 40.

A computing system 50 may contain a data replication management application 60 which may contain various modules and/or components to facilitate data replication management. An interface 70 is a graphical user interface such that a user can operate the functions of the application 60. Also, the interface 70 may be a command line interface for operating the functions of the application 60. The interface 70 may be included in the application 60 or may be a stand-alone program that is separate from the application 60. The application 60 is configured to manage data replication at Site 1 and Site 2, along with any other storage sites. The application 60 is configured as data replication management software to replicate data from various sites to other sites, such as from Site 1 to Site 2 or from Site 2 to Site 1.

Site 1, Site 2, and the computing system 50 may be operatively connected via a network 120. The network 120 allows communications among Site 1, Site 2, and the computing system 50. The network 120 may include circuit-switched and/or packet-switched technologies and devices, such as routers, switches, hubs, gateways, etc., for facilitating communications. The network 120 may include wireline and/or wireless components utilizing, e.g., IEEE 802.11 standards for providing over-the-air transmissions of communications. The network 120 may include IP-based networks for facilitating communications.

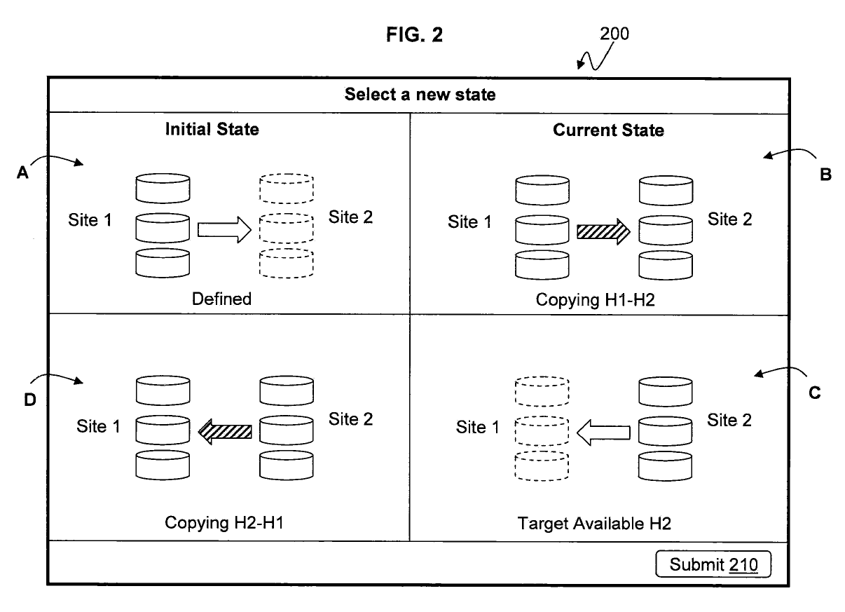

In accordance with exemplary embodiments, the data replication management application 60 can be used to change the paradigm for dealing with commands of replication management software, such as IBM TotalStorage® Productivity Center for Replication, by moving away from typical “action-based” commands. Instead of providing a list of valid commands (for a IBM TotalStorage® Productivity Center for Replication session) at any point in time as is done in the related art, exemplary embodiments can provide a list of desired states for the replication system by using the interface 70 of the data replication management application 60 (e.g., implemented in IBM TotalStorage® Productivity Center for Replication). The user will simply choose the desired state presented by the interface 70 (such as in FIG. 2), and the data replication management application 60 carries out all of the necessary steps to bring about the desired state. Consequently, exemplary embodiments provide a user interface 70 that is more natural for a user. Rather than forcing a user to determine the sequence of steps to get from the current state to the desired state, execute the commands, and monitor the results until the desired state is reached, it is much simpler to allow the user to select the desired state and allow the data replication management application 60 (e.g., implemented in IBM TotalStorage® Productivity Center for Replication) to carry out all of the steps necessary to achieve the desired state.

Further, it is understood that the interface 70 is not limited to a pictorial representation. As discussed herein, it is contemplated that the interface 70 may be a command line interface and instead of selecting a picture, the user may type in the state name to the command. Accordingly, the data replication management application 60 carries out all of the necessary steps to bring about the desired state in accordance with exemplary embodiments.

FIG. 2 illustrates a graphical example of how the user interface 70 may be displayed in accordance with exemplary embodiments. FIG. 2 illustrates a screen 200 that shows a plurality of different states, and it is understood that additional states may be shown in the screen 200 of the interface 70. The screen 200 affords the user an opportunity to select a desired state, e.g., by clicking on the desired state, and the user does not have to be familiar with the necessary steps to accomplish the desired state.

Block A is the initial state of a session, which illustrates that the session is configured and able to copy data from Site 1 to Site 2. At this point (in Block A), no relationships exist on the hardware and no data replication is taking place; the session and the copy sets that it embodies have merely been defined within the application's datastore. When a session is created, this is the default state of the session. A user can return to this state at any time by terminating all data replication relationships in the session.

In exemplary embodiments, Block B is the current state, which illustrates that data is being copied from Site 1 to Site 2. In a command-driven data replication application of existing systems, the number of steps necessary to get to this state depends on the current state of data replication. From the state shown in Block A, typically a single command, such as “Start”, would be issued in order to establish the data replication relationships on the hardware. If the current state was that shown in Block D, multiple commands would be required (to be input by a user), such as Suspend, Recover, and Start in the Site 1 to Site 2 direction, to initiate copying from Site 1 to Site 2.

Block C is a state, which illustrates that the data on target Site 2 is available for use by applications at Site 2. It also indicates that no current data replication is taking place. From the current state depicted in Block B, the copying between Site 1 and Site 2 needs to be suspended. The relationship between Site 1 and Site 2 is then reversed, so that Site 2 is now a suspended primary. This allows change recording to be kept at the secondary site so that only changed data will need to be copied back to the Site 1, if in the future the user desires to copy in the opposite direction. Next, the volumes at Site 2 need to be made accessible for application I/O. In a command driven copy services application (of existing systems), such as the IBM TotalStorage® Productivity Center for Replication, these steps would be accomplished from the current state by issuing the following commands: Suspend (which would suspend the copying between the two sites), and Recover (which would reverse the direction of the relationship and make the Site 2 volumes accessible for application I/O). Furthermore, it would be necessary to wait until the data replication relationship reached a synchronized state before issuing the Suspend command.

Block D is a state, which illustrates copying data from Site 2 to Site 1. This state represents that the user is running production on Site 2, and the changes made to the Site 2 volumes are being replicated to Site 1 via the data replication relationship. The steps necessary to achieve this state from the current state are the same as those for State C, with the additional step of starting the data replication from Site 2 to Site 1.

In the screen 200 of FIG. 2, in State A, no data is being copied and the user is accessing the data at Site 1. In State B, the user is again accessing data at Site 1 but now the data from Site 1 is being copied to Site 2. State C is of the opposite of State A in that no data is being copied but the user is accessing the data at Site 2 instead of Site 1. State D is the opposite of State B in that data is being copied from Site 2 to Site 1.

Underlying commands have been discussed herein which correspond to Blocks A, B, C, and D of FIG. 2. However, the underlying commands (e.g., that must be input by a user in a command-drive data application) do not have to be known by a user utilizing the interface 70 of exemplary embodiments, and the user can select any of Blocks A, B, C, and D and have the proper commands executed.

In accordance with exemplary embodiments, there are many ways that the user can select the desired state (e.g., shown in Blocks A, B, C, and D of FIG. 2) of the interface 70. The user may, e.g., double click on the desired state. Also, the user may highlight the desired state and then select a submit button 210. Further, in a command line or API driven interface, the user may submit the name of the desired state to the application 60, and the application 60 performs the underlying commands.

By combining knowledge of the current state of a session with the IBM TotalStorage® Productivity Center for Replication internal copy rules for a session, IBM TotalStorage® Productivity Center for Replication is modified (with the interface 70 of the data replication management application 60) to carry out all of the steps to get from the current state to the desired state in accordance with exemplary embodiments. The copy rules are an internal representation of all the states, valid commands, possible transitions, and transition events for each session in whatever state it is in. Therefore, IBM TotalStorage® Productivity Center for Replication (modified with the interface 70 of the data replication management application 60) uses the copy rules to provide the steps to go from one state to another. IBM TotalStorage® Productivity Center for Replication will automatically transition through the states until reaching the desired state, at which time control will return to the user for a subsequent desired state change. One skilled in the art understands copy rules associated with data replication management. Also, one skilled in the art understands that the copy rules may include a long list of possible states, command, events, transitions, etc., and there are different copy rules for different session types. For more information regarding copy rules, refer to U.S. Pat. No. 7,376,676 entitled “Method, System, And Program For Autonomic Copy Services Solutions” which is herein incorporated by reference.

The following is an example of an existing data replication management system. Assume a Metro Mirror (MM) session is running from Site 1 to Site 2. In the existing version of IBM TotalStorage® Productivity Center for Replication and other management software suites, the user would have to carry out the following steps to change the session such that it is running from Site 2 to Site 1: (1) Suspend the session, wait for it to suspend; (2) Recover the session to Site 2; and (3) Restart the session in the Site 2 to Site 1 direction.

In the new paradigm according to exemplary embodiments, the user would simply choose the state for replicating from Site 2 to Site 1 using interface 70 of the data replication management application 60 (unlike existing data replication management systems). The modified IBM TotalStorage® Productivity Center for Replication would then carry out the same steps to achieve this new state in exemplary embodiments.

In simplifying the interface 70 to the user, it is interesting to note that if the user wants to have data being replicated from Site 2 to Site 1 in this example, no matter what the current state of the session, he/she would simply choose the same Site 2 to Site 1 state (e.g., shown as Block D in FIG. 2). This is in contrast to currently existing systems where the user would need to know the specific steps that are necessary to get to the state from every different variation of other states (such as session running, session suspended, session target available, etc). The steps necessary to get from the current state to the desired state depend entirely on the current state in existing systems. For instance, if the current state is that shown in Block A in FIG. 2 and the desired state is that shown in Block B in FIG. 2, then the user would simply issue the Start command. However, if the current state was that shown in Block C, in currently existing systems the user would have to carry out the following steps: (1) Issue the Start H2->H1 command; (2) Wait for the Session to reach the Prepared State; (3) Issue the Suspend command; (4) Wait for the session to reach the Suspended state; (5) Issue the Recover command; (6) Wait for the session to reach the Target Available State; and (7). Issue the Start H1->H2 command.

Furthermore, if the current state is somewhere in between these two states, the user must know which command to start with and the order of commands to follow in existing systems. Therefore, in accordance with exemplary embodiments, simply selecting the desired state and allowing the data replication management software to ensure that the proper commands are executed reduces the complexity of the replication system to the user.

This is novel as it is a completely different paradigm of approaching this type of replication system. It is also novel to use knowledge of the current state, the desired state, and use the IBM TotalStorage® Productivity Center for Replication copy rules to provide the steps to get from the current state to the desired state in accordance with exemplary embodiments.

Although illustrations herein may be implemented using the IBM TotalStorage® Productivity Center for Replication, it should be appreciated that the invention is not restricted to the IBM TotalStorage® Productivity Center for Replication storage system. Rather, the invention may be applicable for any type of data replication management system. Also, there are other algorithms that could be used to provide the steps necessary to move from the current state to the desired state. For example, other possible algorithms for determining the steps to take may include: creating a list of the steps to get from any state to any other state; using a path finding algorithm to examine the current state, desired state, and possible steps in between to optimize the steps taken; using a “hub” approach where steps are determined to get from any state to the “hub” state and from the “hub” state to any other state.

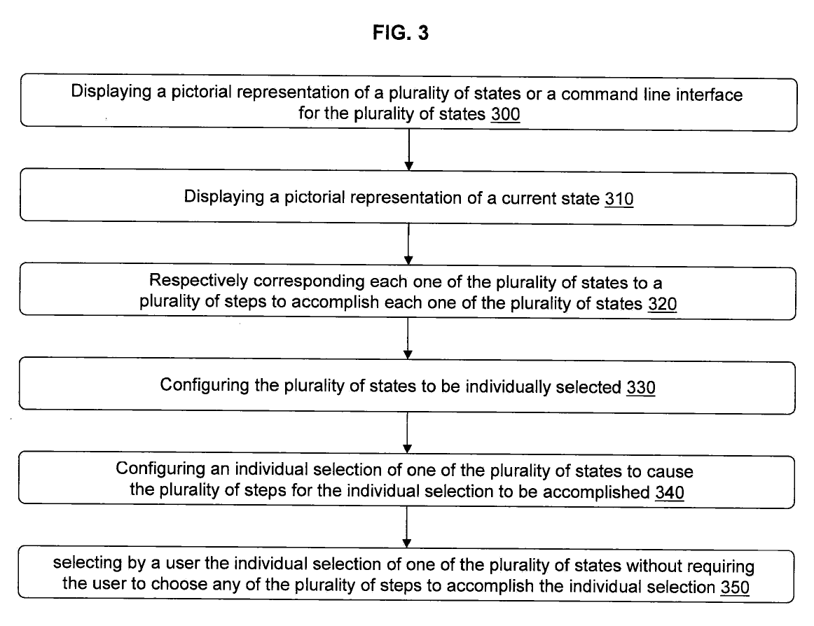

FIG. 3 illustrates a method for providing a data replication management interface (such as the interface 70) for selecting a state to replicate data from one site to another site in accordance with exemplary embodiments.

The interface 70 may display a pictorial representation of a plurality of states and/or display a command line interface for the plurality of states at 300. The interface 70 may also display a pictorial representation of a current state at 310.

In the application 60, each one of the plurality of states respectively corresponds to a plurality of steps to accomplish each one of the plurality of states at 320.

In the application 60, the plurality of states is configured to be individually selected at 330. An individual selection of one of the plurality of states causes the plurality of steps for the individual selection to be accomplished at 340.

Using the interface 70 of the application 60, the individual selection of one of the plurality of states can be selected by a user without requiring the user to choose any of the plurality of steps to accomplish the individual selection at 350.

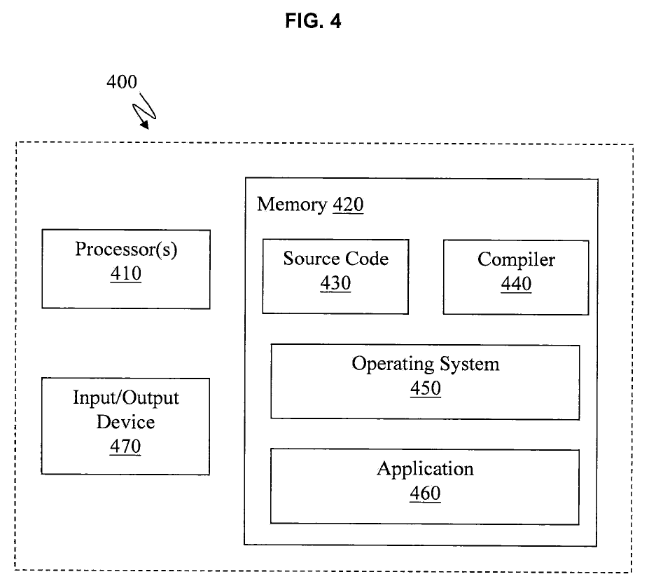

FIG. 4 illustrates an example of a computer 400 having capabilities, which may be included in exemplary embodiments. Various operations discussed above may also utilize the capabilities of the computer 400. One or more of the capabilities of the computer 400 may be incorporated in any element, module, or component discussed herein.

The computer 400 includes, but is not limited to, PCs, workstations, laptops, PDAs, palm devices, servers, storages, and the like. Generally, in terms of hardware architecture, the computer 400 may include one or more processors 410, memory 420, and one or more input and/or output (I/O) devices 470 that are communicatively coupled via a local interface (not shown). The local interface can be, for example but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the aforementioned components.

The processor 410 is a hardware device for executing software that can be stored in the memory 420. The processor 410 can be virtually any custom made or commercially available processor, a central processing unit (CPU), a data signal processor (DSP), or an auxiliary processor among several processors associated with the computer 400, and the processor 410 may be a semiconductor based microprocessor (in the form of a microchip) or a macroprocessor.

The memory 420 can include any one or combination of volatile memory elements (e.g., random access memory (RAM), such as dynamic random access memory (DRAM), static random access memory (SRAM), etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 420 may incorporate electronic, magnetic, optical, and/or other types of storage media. Note that the memory 420 can have a distributed architecture, where various components are situated remote from one another, but can be accessed by the processor 410.

The software in the memory 420 may include one or more separate programs, each of which comprises an ordered listing of executable instructions for implementing logical functions. The software in the memory 420 includes a suitable operating system (O/S) 450, compiler 440, source code 430, and application 460 in accordance with exemplary embodiments. As illustrated, the application 460 comprises numerous functional components for implementing the features and operations of the exemplary embodiments. The application 460 of the computer 400 may represent various applications, computational units, logic, functional units, processes, operations, virtual entities, and/or modules in accordance with exemplary embodiments, but the application 460 is not meant to be a limitation.

The operating system 450 controls the execution of other computer programs, and provides scheduling, input-output control, file and data management, memory management, and communication control and related services. It is contemplated by the inventors that the application 460 for implementing exemplary embodiments may be applicable on all commercially available operating systems.

The application 460 may be a source program, executable program (object code), script, or any other entity comprising a set of instructions to be performed. When a source program, then the program is usually translated via a compiler (such as the compiler 440), assembler, interpreter, or the like, which may or may not be included within the memory 420, so as to operate properly in connection with the O/S 450. Furthermore, the application 460 can be written as (a) an object oriented programming language, which has classes of data and methods, or (b) a procedure programming language, which has routines, subroutines, and/or functions, for example but not limited to, C, C++, C#, Pascal, BASIC, API calls, HTML, XHTML, XML, ASP scripts, FORTRAN, COBOL, Perl, Java, ADA, NET, and the like.

The I/O devices 470 may include input devices such as, for example but not limited to, a mouse, keyboard, scanner, microphone, camera, etc. Furthermore, the I/O devices 470 may also include output devices, for example but not limited to a printer, display, etc. Finally, the I/O devices 470 may further include devices that communicate both inputs and outputs, for instance but not limited to, a NIC or modulator/demodulator (for accessing remote devices, other files, devices, systems, or a network), a radio frequency (RF) or other transceiver, a telephonic interface, a bridge, a router, etc. The I/O devices 470 also include components for communicating over various networks, such as the Internet or intranet.

If the computer 400 is a PC, workstation, intelligent device or the like, the software in the memory 420 may further include a basic input output system (BIOS) (omitted for simplicity). The BIOS is a set of essential software routines that initialize and test hardware at startup, start the O/S 450, and support the transfer of data among the hardware devices. The BIOS is stored in some type of read-only-memory, such as ROM, PROM, EPROM, EEPROM or the like, so that the BIOS can be executed when the computer 400 is activated.

When the computer 400 is in operation, the processor 410 is configured to execute software stored within the memory 420, to communicate data to and from the memory 420, and to generally control operations of the computer 400 pursuant to the software. The application 460 and the O/S 450 are read, in whole or in part, by the processor 410, perhaps buffered within the processor 410, and then executed.

When the application 460 is implemented in software it should be noted that the application 460 can be stored on virtually any computer readable medium for use by or in connection with any computer related system or method. In the context of this document, a computer readable medium may be an electronic, magnetic, optical, or other physical device or means that can contain or store a computer program for use by or in connection with a computer related system or method.

The application 460 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium.

More specific examples (a nonexhaustive list) of the computer-readable medium may include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD RIW) (optical). Note that the computer-readable medium could even be paper or another suitable medium, upon which the program is printed or punched, as the program can be electronically captured, via for instance optical scanning of the paper or other medium, then compiled, interpreted or otherwise processed in a suitable manner if necessary, and then stored in a computer memory.

In exemplary embodiments, where the application 460 is implemented in hardware, the application 460 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

It is understood that the computer 400 includes non-limiting examples of software and hardware components that may be included in various devices and systems discussed herein, and it is understood that additional software and hardware components may be included in the various devices, modules, and systems discussed in exemplary embodiments.

Indeed, the capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While exemplary embodiments to the invention have been described, it will be understood that those skilled in the art, both now and in the future, may make various improvements and enhancements which fall within the scope of the claims which follow. These claims should be construed to maintain the proper protection for the invention first described.

What is claimed is:

1. A data replication management interface for selecting a state for replicating data from one site to another site, the interface comprising:
at least one of a pictorial representation of a plurality of states and a command line interface for the plurality of states;
a representation of a current state;
wherein each one of the plurality of states respectively corresponds to a plurality of steps to accomplish each one of the plurality of states;
wherein the plurality of states are configured to be individually selected;
wherein an individual selection of one of the plurality of states causes the plurality of steps for the individual selection to be accomplished; and
wherein the individual selection of one of the plurality of states is selected by a user without requiring the user to choose any of the plurality of steps to accomplish the individual selection.

2. The interface of claim 1, wherein the individual selection is received from the user without requiring the user to address whether a session is running, a session is suspended, or a session target is available.
